(19) United States
(12) Patent Application Publication
(10) Pub. No.: US 2001/0047306 A1
(43) Pub. Date: Nov. 29, 2001

(54) Electronic merchant system

(76) Inventor: John E. Garretson, Paradise Valley, AZ (US)

Correspondence Address: Joseph H. Roediger, 3333 E. Camelback Rd., Ste. 212, Phoenix, AZ, 85018, US

(21) Appl. No.: 09/796,912

(22) Filed: Mar. 1, 2001

Related U.S. Application Data
(60) Provisional application No. 60/186,460, filed on Mar. 2, 2000.

(51) Int. Cl. G06F 17/60

(52) U.S. Cl. 705/26

(57) ABSTRACT

A system for the on-line ordering of goods followed by the pickup of the goods from the store. A web server is used to conduct the transaction with a database resident on a database server. Each store in the system has a local server that maintains a local inventory and price schedule. The purchaser is provided with a printed list having the ordered items set out in a manner which describes a preferred pathway through the store. Price changes and rebates between the time or ordering and pick up along with location data are resident in the database server.

### CROSS REFERENCE TO RELATED APPLICATION

The present invention is based on provisional patent application Ser. No. 60/186,460 filed Mar. 2, 2000.

### BACKGROUND OF INVENTION

This invention relates generally to an interactive electronic merchant system for the on-line ordering of goods. More particularly, the system is directed to on-line ordering of goods followed by later acquisition of the goods by the customer at one of a number of stores or distribution centers.

The ever-increasing use of the Internet by consumers to order goods has generated a need for procedures and systems that broaden and facilitate electronic purchasing. Acceptance of an on-line review of offerings displayed at a computer terminal accompanied by selection and payment is now widespread. The process concludes with a third party delivery of the goods to the consumer. This method of commerce works well for orders of a limited number of packaged goods which are nonperishable and not normally the subject of varying price changes.

When current Internet ordering systems are applied to purchasing orders comprising a multiplicity of articles that have a finite useful life or are subject to time-dependent promotions, the use of third party delivery systems creates difficulties for both seller and purchaser. Promotions are typically made available to prospective buyers within a defined class by means of specialized advertisements containing coupons. The advantages of coupons are obtained by presentations of the physical coupon. The on-line purchaser receiving goods via a third party deliverer forgoes receiving the advantages of favorable promotions and recent price changes. Either the buyer is resigned to not receiving these advantages or he elects to make his purchases in a different manner from another seller of the goods.

Furthermore, the ordering of a large number of items via the Internet is likely to result in a seller's in ability to satisfy the request completely. Errors in shipment date or delivery address, a damaged condition of individual items, departures from the initial order list, either through error or non-availability of products create problems which lead to customer dissatisfaction with Internet commerce as now practiced. Also, the typical sales promotions used by manufacturers and merchants are not readily available to the on-line buyer of goods for future delivery. The avenue of advertising which utilizes price discounts, rebates, and coupon presentation is not only ineffective, but also leaves the on-line buyer unsure that the goods are being purchased at the best available current price. At present, the buyer is left to bear the risk of price increases for unavailable items earmarked for later delivery. In addition, food purchases by a meal planner frequently cannot effectively utilize a partial or incomplete delivery.

In spite of these defects in the purchasing process, the Internet continues to expand. In order for the physical retail outlet to continue to attract purchasers in the future, the stores will have to incorporate the Internet into their overall retail strategy in a manner which blends on-line purchasing with store pickup. The seller of goods from multiple brick-and-mortar stores is going to be required to provide on-line purchasers with the advantages available to cost-conscious shoppers that visit the stores, and do so in a manner that provides the on-line purchaser with reasonable assurance that the goods ordered will be available at the time the order is assembled at the store. Furthermore, lost bargains due to the subsequent unavailability of goods after an on-line purchase have to be made available to the purchaser for an effective purchasing process.

Accordingly, the present invention is directed to a system for facilitating on-line purchasing by determining the lowest cost of each item at the time of ordering or the time of assembling the order at the store. The system provides the purchaser with a review of the availability of goods at different store locations at the time of on-line purchase, renders a total cost at the time of ordering, adjusts for later price changes, discounts, rebates and the like and preserves any lost opportunity due to later unavailability of goods. The present system receives the on-line purchasing decisions for goods to be gathered by the purchaser or its agent at the selected site and enables the purchaser to add or delete items from the initial order thereby eliminating most of the return of goods problems inherent in present electronic purchasing with third party delivery service.

After the on-line purchase order is made, the purchaser is drawn to the retail distribution center by the present system so that the merchant's in store offerings are presented to the purchaser. The location of the goods in each distribution center is noted in the purchase record printed out at the shopper's terminal to simplify the assembling of the goods and related coupons by the purchaser. In addition, the system is capable of providing the purchaser with a suggested route through the distribution center to improve the efficiency of the gathering of the ordered items and to enable the merchant to steer the purchaser through the various displays in a pattern selected by the merchant. The pattern out-lined can reflect the purchasing history of an individual customer so as to emphasize current sales discounts on goods that have appealed to the customer in the past.

### SUMMARY OF THE INVENTION

This invention relates to a method and apparatus for enabling the on-line purchaser of goods to receive the lowest cost available taking into account any local store discounts, manufacturer rebate coupons and pricing variations occurring between the time of purchase and the time of picking up the purchased items at the store.

The present system for facilitating the on-line ordering and payment by the customer of multiple items for later pickup from a distribution center provides the customer with pricing and location data for each item at the time of ordering and at anytime up to the time of pick up of the goods at the distribution center. A first server herein termed the web server is accessible to the customer and is provided to verify customer identity, display item availability at the multiple stores forming the distribution network and to accept the customers order and the store selection. A second server herein termed the database server communicating with the web server to receive the customer order data maintains current inventory, pricing and location data for items at the selected store resident therein. The acquisition of the purchased goods can take place days after the placement of the order so the database server is continually updated to reflect current data throughout the system.

Since the present system is intended to serve a multiple distribution center network, a plurality of third servers, herein termed store servers, each containing inventory, price and location data from one of the centers, communicate with the database server. Also, a display device and printer communicating with the database server is located at each center in the preferred embodiment of the invention. The display device is available to the on-line purchaser or its agent to confirm the content of the initial order, note any price changes or product availability.

Point-of-sale terminals communicating with the database server are used to verify price and quantity of customer selected items. A comparison of these items with the initial order resident in the database server is made at the point of sale terminal to refigure the current cost to the customer reflecting additions and subtractions to the purchase order as well as reflecting price changes to provide the lowest item cost. A comparison of item pricing at date of ordering and date of pickup at the center is made and the lowest price is used. In addition, the absence of selected items from inventory at time of pickup is noted and the price and item are reflected in a data entry in the purchaser's account as stored in the database server. The store server receives the data on purchases from the point-of-sale terminals and also any changes in inventory or pricing data due to store personnel activity. The localized price reductions are entered into the store servers at each distribution center.

The distribution center has a coded series of aisles and shelves which enables items to be located in the center. The item locations for all of the centers is maintained in the database server. This data is provided to the purchaser prior to the visit to the center to pick-up the ordered items. The database server contains the program to order the path of the purchaser accordingly to a least path methodology to save the purchaser time or, alternatively, the purchaser may be directed along a path which travels past goods that the merchant wishes to emphasize or purchaser's past history indicate that a purchase is likely.

In the practice of the present method, a comprehensive database containing price inventory and location information is generated and made resident in a database server. The database server is provided with this information for each location in the distribution network. Also, the physical location of the items at each distribution location is coded and this information is made resident in the database server.

The system presents a description of each item taken from the database at a terminal available to the customer thereby enabling the customer to make initial purchasing decisions via the terminal. After purchasing decisions have been made and entered, the status of the customer is verified and payment made, the customer is furnished a printout of the order showing the coded location of each selected item at the distribution center and, if desired by the purchaser, a suggested travel path through the center.

When the customer arrives at the distribution center and selects those items of interest, the point-of-sale terminal compares the identity, quantity and price of items with the initial list of purchases and adjusts not only for additions and subtractions to the list but also takes into account price changes. Any changes in price from the time of placing the initial order for initially selected and purchased items are resident in the database server so that the lowest price is assigned to the item. The credit is applied to additional purchases not found on the initial list or applied to the purchaser's account. Any additional rebates due the purchaser are presented at the point-of-sale terminal.

The present method enables the operator of the distribution center to design a path through the center for each customer taking into account not only the items selected on this particular purchasing trip but also based on the customer's historical purchasing record and any variations in path that the operator cares to use to stimulate sales of other products. A primary advantage of the system is the use of local inventory control at a server at each store to generate a deferred purchase notation at a particular price should the center lack an item at the time of the pickup of the purchased goods. That information is stored in the database server for use at the time of the next purchase.

Further features and advantages of the invention will become more readily apparent from the following detailed description of a preferred embodiment of the invention when taken in conjunction with the accompanying drawings.

### BRIEF DESCRIPTION OF THE DRAWINGS

FIG. 1 is block diagram of a prior art system used for the on-line purchasing of goods.

FIG. 2 is a block diagram of a preferred embodiment of the present invention.

FIG. 3 is a flow chart showing the activity sequence at the user terminal of the present invention.

FIG. 4 is a flow chart showing the procedure employed in the present invention.

### DESCRIPTION OF THE PREFERRED EMBODIMENT

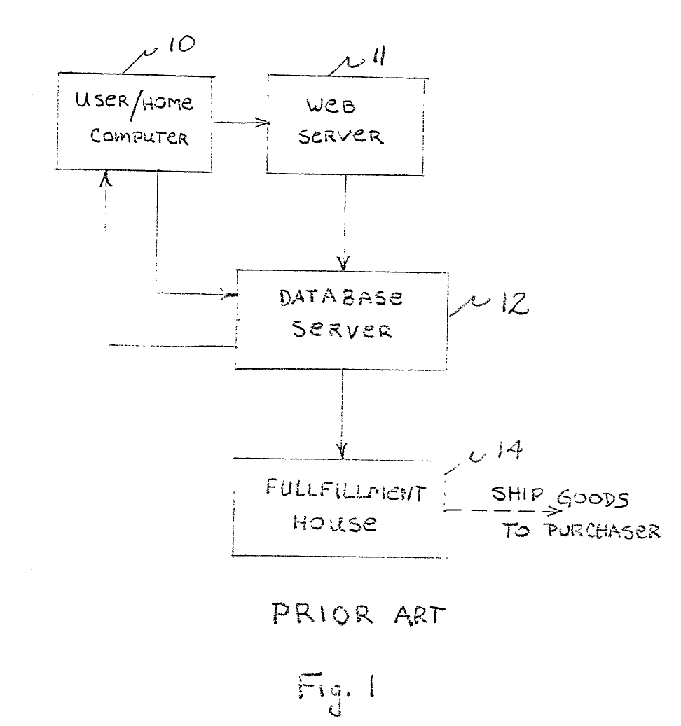

Referring now to FIG. 1, the established prior art system and method of conducting electronic commerce begins with the user operating from a home computer 10 which accesses the web server 11 hosted by the operator of the system. The web server serves as the interface between the database server 12 and the user and contains the CGI software (Common Gateway Interface) which regulates the interconnection, verifies the customers identity and credit and enables the database server to display the items being offered for sale on the home computer. The database server 12 contains the item identification, price at the time of access and availability information. The customer or user places an order which is entered into the database server and is also provided to the fulfillment house 14. The fulfillment house stores the order information and ships the goods by third party carrier, such as UPS, FED EX or USPS, to the address entered by the user.

The present mode of conducting electronic business has limitations that make these systems impractical for the delivery of goods subject to varying pricing or sales promotions such as coupons. The reliance on third party shippers introduces an additional barrier between buyer and seller making returns and mis-deliveries an expensive experience for at least one of the parties. Also, the full online shopping experience eliminates the merchants opportunity to present additional merchandise in a retail store environment.

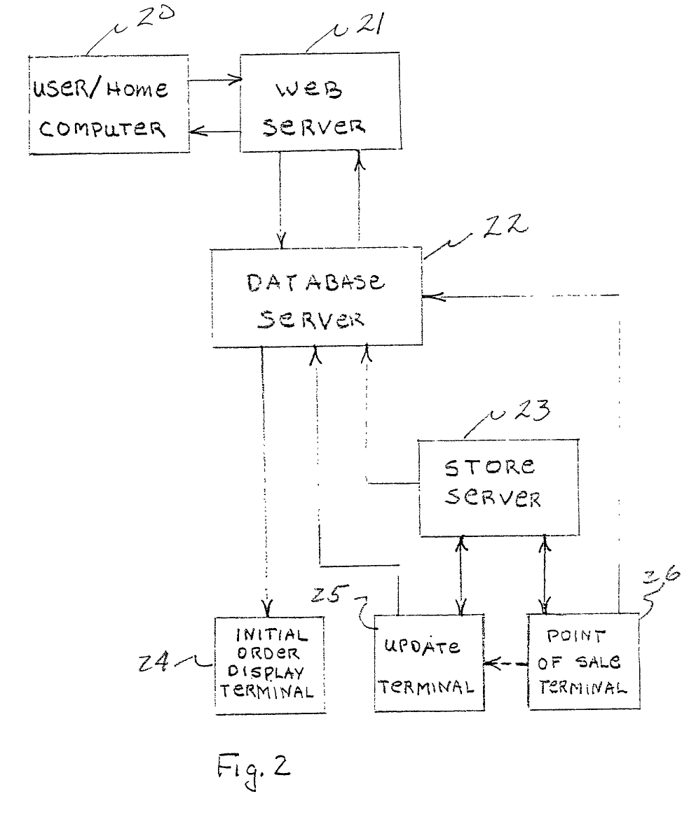

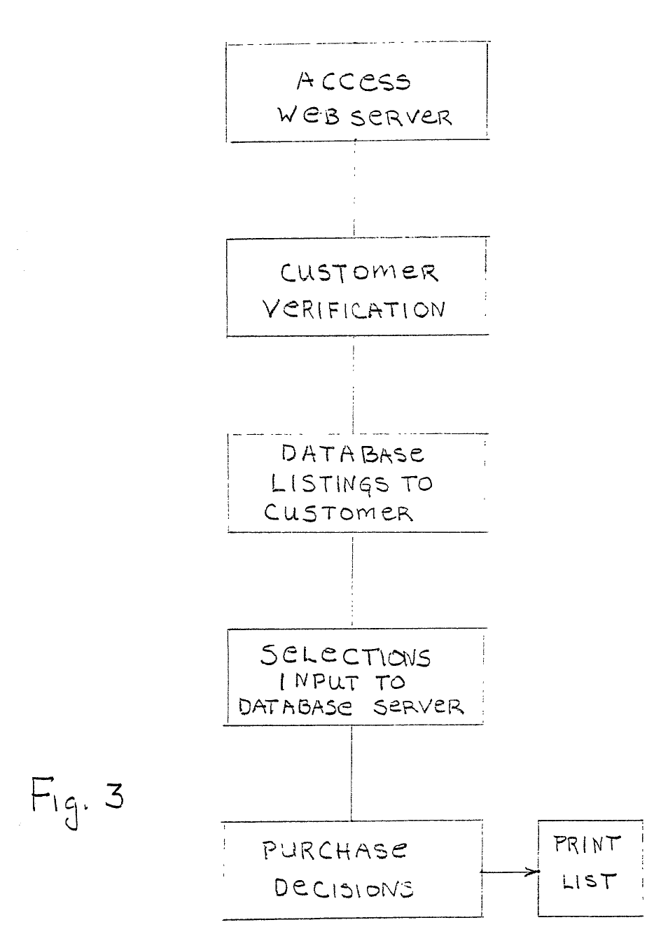

The preferred system as applied to a single store location is shown in the block diagram of FIG. 2 wherein three servers are maintained by or for the operator. The user/purchaser at the home computer terminal 20 is connected to the web server 21 which is the sole interface between purchaser and the present system. The web server contains the CGI software and accesses the database server to receive and display the list of items available at the different distribution centers and the current pricing therefor. The items can be listed in alphabetical order for customer convenience or grouped in accordance with customer preference. The procedure for the preferred embodiment is shown in the flow diagram of FIG. 3 which calls for the user to log in, enter credit card type and number. If verified, the user selects a specific store location and, if another party is to retrieve the purchased goods, an identifier for the party is entered.

At that point, the web server calls on the CGI software program to access the database server to present the list of items, any specials being offered, the expiration date of quoted prices, any open prior transactions and any unused “rain checks” for previously unavailable goods. Various graphics can be employed to display an emphasize special pricing. Alternately, the customer verification can take place after the customer makes the selection of items to be purchased.

When the order is complete, the CGI program sends the information to the database server and asks if the customer wants a printed confirmation list. If the list option is selected, the list is printed with the following information: the item identifier and on-line price, the expiration date of that price and any coupon tied to that item, the location of each item in the selected distribution center along with an arrangement of items in an order chosen according to the most efficient pathway through the center.

After the purchaser has completed ordering on the home computer terminal, the information is provided to the database server which serves as the repository for all customer transactions, the distribution center locations and the inventory in each center. Thus, the database server is accessed by the web server only to provide data and after the customer has completed his selection of items to be purchased. As shown in FIG. 2, the database server is coupled to an individual store server 23, and maintains a database showing the inventory for each item at that store and the coded location of each item in that store. Inventory adjustments made as a result of customer selections are provided by terminal 26 and change due to the restocking or removal of items are provided by the update terminal 25. The data is supplied to the database server 22 so as to maintain a current database for the web server. It is to be noted that the point of sale terminal interacts with the database server not the web server to promote security, reduce traffic on the web server and provide a prompt response to inventory changes.

An initial order display terminal 24 is located at each distribution center or store to enable the customer to review the purchase list or print a duplicate. This printout capability is a preferred option for terminal 24 and, upon verification of the customer's identity typically by use of a credit or debit card number, the already pre-ordered shopping list and suggested routing through the store is made available on site. As the customer moves through the store, additions and subtractions from the list can be made according to customer preferences at the time. Upon completion of the gathering of the goods, the customer presents the credit card and the order list is provided to the point-of-sale terminal from the database server and the goods for scanning by a conventional merchandise scanner at the point-of-sale terminal 26.

After each item is scanned, the software program at terminal 26, checks each item against the purchase list to determine if there is a lower applicable sales price that has been put into effect between the date of the order and the present day and, if so, the lower price is assigned. Similarly if it is a sale item and the sales price is no longer applicable, the appropriate adjustment is made. An explanation of pricing changes is stated on the receipt next to each item. If an item not on the initial purchase list has been added, the current store price is applied. Next, the total price of purchased items is computed and indicated on the receipt with credit given for any deleted items. A credit or debit amount reflected variations in pricing subsequent to placement of the initial order through the home computer is printed on the receipt and labeled prepaid price adjustment. Additional items are separately identified on the receipt.

The point-of-sale terminal is used to scan coupons and to verify that the corresponding item was purchased. The valid coupons are totaled and labeled as such on the receipt. The final total and tax are computed with credit given for the on-line purchase amount. The receipt is signed by the purchaser and terminal 26 writes the competed transaction to database server 22. If an on-line purchased item is out of inventory, price credit has been given and an additional notation made in the customer's file that an option to later purchase this item at the stated price is available to this purchaser.

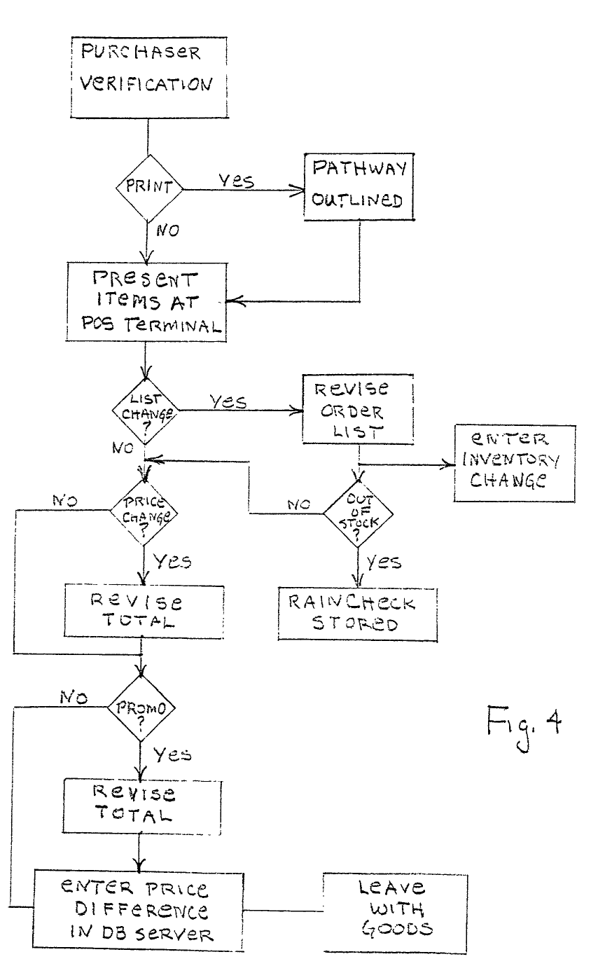

The activity taking place at the store is explained with the use of the flow diagram of FIG. 4 wherein the purchaser arriving at the selected location after having placed and paid for the on-line order on the home computer uses the credit or debit card at the initial order display terminal for verification. The initial order was made resident in the database server and is now available to the verified purchaser, or the nominee in printed form. Both the on-line printed list and the store printed list will have the coded location of the items in the store and the suggested pathway to be taken to retrieve these items. As noted previously, the pathway generated may be created by using a least path method to provide the shortest travel path through the store or can reflect the system operator's designed pathway to enhance the exposure of the purchaser to new and different items or specially priced items. The selected items are presented at the point-of-sale terminal and a scan is made to see if there are departures from the on-line list. Review is made to see if there are departures from the list because of exhausted inventory. If so, the inventory change is provided to both the store server and the update terminal. The inventory data is transferred to the database server. If the item is out of stock then a rain check is noted at the terminal and the data is transferred to the purchaser's account in the database server. The items on the initial or revised order list are price checked for departures from the price in effect at the time of placement of the on-line order. If so, the total is revised. Following that step, the point-of-sale terminal accepts coupons and checks the items on the list to determine what, if any, promotions have affected the pricing. The total is again revised accordingly. A comparison of the final revised total versus the on-line order total is made and any price difference is entered into the purchaser's account in the database server along with the raincheck notation. At that point, the purchaser or nominee has completed the transaction and leaves with the goods.

The present invention provides an apparatus and method for enhancing the speed efficiency and convenience of shopping for the Internet purchaser and makes it attractive to the purchaser to visit the physical store location in order to enjoy the potential financial benefits stemming from the application of the various price savings. The item list with is intended to be used to eliminate the time-consuming search for specific products that is so characteristic of shopping in a large store. The coding of the location of items in the store can be effected by any of a number of schemes with the aisle designation followed by horizontal and vertical calibrated indicia which is compatible with the configuration of shelving now used commercially. While the foregoing description has referred to a specific embodiment of the invention it is recognized that variations and modifications may be made therein without departing from the scope of the invention as set forth in the claims.

What is claimed is:

1. Apparatus for facilitating the on-line ordering and purchasing of items to be later collected at a store, said apparatus providing the customer with pricing data for ordered items at the time of ordering and at the later time of collection, said apparatus comprising:
a) a first server accessible from a remote customer terminal for verifying customer identity, indicating item availability, and accepting a customer order;
b) a second server having resident therein inventory and pricing data for items at the store and customer account data therein, said server communicating with the first server to receive customer order data;
c) a third server communicating with the second server and having current inventory and current pricing data therein;
d) a display device located at the store and communicating with the second server and providing a confirmation of an initial customer order;
e) a point-of-sale terminal communicating with the second and third servers for verifying current price and quantity data of collected items, comparing said data with the initial order and refiguring the current cost to the customer; and
f) an update terminal communicating with the second and third servers for adjusting inventory data in said servers to reflect current inventory levels at the store.

2. The apparatus of claim 1 further comprising indicia displayed at each store for designating item locations, and wherein said second and third servers have resident therein location data for items at the store, the second server communicating item locations for the customer order to the first server.

3. The apparatus of claim 2 wherein said second server includes a program for outlining a pathway through the store for the customer order.

4. The apparatus of claim 3 wherein said second server outlines the shortest path through the store for the customer order.

5. The apparatus of claim 4 further comprising a plurality of point-of-sale terminals, each of said terminals communicating with the second server.

6. The apparatus of claim 5 for use with a number of stores which comprises a plurality of third servers communicating with the second server, each third server receiving data from one store, and a like plurality of display devices and update terminals, at least one display device and update terminal located at each store and at least one point-of-sale terminal at each store.

7. The apparatus of claim 6 wherein said second server has resident therein the location data for said number of stores and the program therein outlines a pathway through each of the stores in accordance with customer selection.

8. The apparatus of claim 7 wherein said point-of-sale terminals identify nonavailability or ordered items and transfer the resulting data to the second server.

9. The apparatus of claim 8 wherein the second server maintains data account for each customer.

10. The apparatus of claim 9 wherein said second server has resident therein a common gateway interface available to the web server.

11. A method facilitating the on-line acquisition of selected items for later collection from a distribution center which comprises the following steps:
1. coding the location of said items within the distribution center;
2. generating a database containing price, quantity and location information for each item at the center;
3. displaying a description and on-line price of each said item from the database at a remote terminal to enable a customer to enter an indication of purchase;
4. accepting a customer request to purchase and payment therefor and further providing the coded location of each selected item in each request;
5. comparing the identity, quantity and price of items at the time of collection of said items at a distribution center with the items of the initial customer request to purchase and;
6. utilizing the database to develop the total sum due for the selected items.

12. The method of claim 11 further comprising the step of generating a pathway for the collection of the items at the distribution center.

13. The method of claim 12 wherein the step of generating a pathway includes generating the shortest path.

14. The method of claim 12 further comprising the step of adjusting the total sum due to reflect the lower of the on-line price and the price at the time of collection for each item.

15. The method of claim 14 further comprising the step of adjusting the total sum due to reflect promotional price changes.
